(19) United States
(12) Patent Application Publication
(10) Pub. No.: US 2009/0118463 A1
(43) Pub. Date: May 7, 2009

(54) Ink channel forming member

(75) Inventors: Akihito Sao, Matsumoto-shi (JP); Kazuhiko Kitamura, Matsumoto-shi (JP); Yasunori Koike, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/291,109

(22) Filed: Nov. 6, 2008

(30) Foreign Application Priority Data
Nov. 6, 2007 (JP) 2007-289053

(51) Int. Cl. C08G 65/06

(52) U.S. Cl. 528/421

(57) ABSTRACT

An ink channel forming member, wherein a layer containing a diacetylene tetraol compound represented by General Formula 1 below is formed on the surface of a base material, and the layer inhibits adhesion of air bubbles thereto:

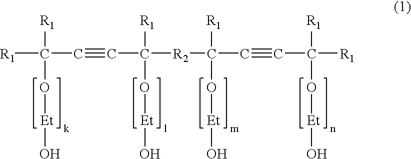

(wherein R₁ and R₂ each independently represent an alkyl group of to 3 carbon atoms; —O-Et- represents an oxyethylene group; and k, l, m, and n each represent an integer from 0 to 2).

The entire disclosure of Japanese Patent Applications No. 2007-289053, filed Nov. 6, 2007, is expressly incorporated by reference herein.

### BACKGROUND

1. Technical Field

The present invention relates to a novel ink channel forming member to be applied in inkjet recording, and more particularly to an ink channel forming member by which normal ejection during inkjet recording can be obtained by reducing the detrimental effects caused by air bubble adhesion to the member.

2. Related Art

The inkjet recording method is a printing method wherein droplets of ink are ejected through the air from a fine nozzle and deposited on a recording medium such as paper and the like. This method enables high speed printing of a high resolution, high quality image with a relatively inexpensive device. Inkjet recording devices using this method have been widely accepted commercially due to their excellent printing quality, low cost, relatively quiet operation, and graphic-forming capabilities. Among these, thermal (Bubblejet™) and piezoelectric drop-on-demand printers have been particularly successful in the market, and they are widely used as personal computer printers in the office and at home.

In particular, the piezoelectric drop-on-demand printers have made it possible to handle a wide range of physical properties in the ink to be ejected by adapting to the given electrical properties thereof. In recent years their use has expanded into an increasingly wider range of fields, and more integrated, higher density nozzles have been designed in response to the desire for enhanced print quality and increased printing speed. This greater complexity in head structure has been accompanied by an increased complexity in the ink channels.

On the one hand, if air bubbles are present in the ink channels of the highly versatile piezoelectric drop-on-demand printer, the generated ejection energy is not accurately transferred to the ink, and the ejection can become unstable.

To prevent such air bubbles in ink channels from adhering to and remaining in the channel forming members, a cleaning solution is used to flush away foreign substances that can become sites of air bubble adhesion (JP-A-2005-7703). Although flushing away foreign substances in the channels reduces the adhesion of air bubbles thereto, it does not reduce adhesion to the channel forming members themselves, and a solution to that problem is still needed.

### SUMMARY

The invention takes into consideration the above facts concerning the ink channel forming members used in the inkjet recording method and makes it possible to reduce the adhesion of air bubbles to the ink channel forming members and to obtain normal ejection thereby.

The inventors conducted insightful research and obtained knowledge that the above problem can be solved by forming a layer containing a specific diacetylene tetraol compound on the surface of the ink channel forming member as a method of preventing the adhesion of air bubbles thereto.

The invention is based on this knowledge, and it achieves the object by providing the following features.

1. An ink channel forming member, wherein a layer containing a diacetylene tetraol compound represented by General Formula 1 below is formed on the surface of a base material, and the layer inhibits adhesion of air bubbles thereto:

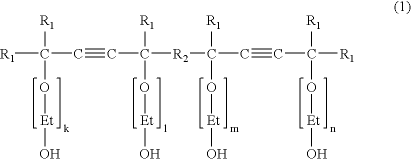

(wherein R₁ and R₂ each independently represent an alkyl group of 1 to 3 carbon atoms; —O-Et- represents an oxyethylene group; and k, l, m, and n each represent an integer from 0 to 2).

2. The ink channel forming member according to 1 above, wherein the layer is formed by immersing the base material in a liquid composition containing the diacetylene tetraol compound.

3. The ink channel forming member according to 2 above, wherein, after the immersion, 10% or more of the volume of the liquid composition adhering to the base material is dried thereon.

4. The ink channel forming member according to 2 above, wherein the immersion is performed for 3 days or more at normal temperature or above.

In accordance with the invention it is possible to provide an ink channel forming member wherein normal ejection is obtained by reducing the detrimental effects of air bubble adhesion during the inkjet recording process.

### DESCRIPTION OF EXEMPLARY EMBODIMENTS

The ink channel forming member of the invention is described below based on exemplary embodiments thereof.

The ink channel forming member of the invention is one wherein a layer containing the diacetylene tetraol compound represented by General Formula 1 below is formed on the surface of the base material thereof, and that layer inhibits the adhesion of air bubbles thereto:

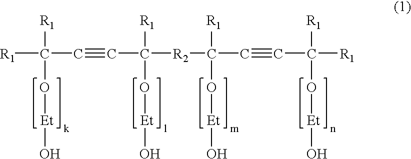

(wherein R₁ and R₂ each independently represent an alkyl group of 1 to 3 carbon atoms; —O-Et- represents an oxyethylene group; and k, l, m, and n each represent an integer from 0 to 2).

As a result of the above feature, the invention makes it possible to provide inkjet recording wherein normal ejection is obtained by reducing the detrimental effects on the ink channel forming member caused by air bubbles.

The member of the invention comprises one wherein a layer containing the diacetylene tetraol compound represented by General Formula (1) above is formed on the surface of the base material thereof, and preferably, one wherein the base material is immersed in a liquid composition containing the diacetylene tetraol compound to form that layer.

The formation of the layer on the member of the invention is preferably accomplished by immersion in the liquid composition and drying of at least 10% or more of the volume of the liquid composition thereon. Within this range, formation of a layer containing a sufficient amount of diacetylene tetraol compound becomes possible.

The formation of the layer on the member of the invention is preferably accomplished by long-term immersion in the liquid composition at a high temperature, and more preferably, by immersion for at least 3 days or more at normal temperature or above. Within this range, formation of a layer containing a sufficient amount of diacetylene tetraol compound becomes possible.

The formation of the layer on the member of the invention is preferably accomplished by including 0.05 wt % or more of the diacetylene tetraol compound in the liquid composition. Within this range, formation of a layer containing a sufficient amount of diacetylene tetraol compound becomes possible.

One type or a mixture of two or more types of the diacetylene tetraol compound represented by General Formula (1) can be used in the invention.

The formation of the layer on the member of the invention is preferably accomplished by decreasing the surface tension of the liquid composition, and in particular, a surface tension of 30 mN/m or less at 25° C. is more preferred.

The use of water or a mixture of water and a water-soluble organic solvent as the main solvent of the liquid composition used for forming the layer on the member in the invention is preferred to obtain a suitable drying rate.

A composition containing, as needed, a humectant, viscosity modifier, and other additives (described below) can be used for the liquid composition.

Specific examples of the water-soluble organic solvent include propylene glycol, butane diol, pentane diol, 2-butene-1,4-diol, 2-methyl-2,4-pentane diol, 1,2,6-hexane triol, diethylene glycol, triethylene glycol, dipropylene glycol and other polyhydric alcohols; methyl diglycol, ethyl diglycol, butyl triglycol, hexyl glycol, 2-ethyl hexyl glycol, and other glycol ethers; methyl alcohol, ethyl alcohol, n-propyl alcohol, n-butyl alcohol, and other alkyl alcohols; acetonyl acetone and other ketones; γ-butryolactone, triethyl phosphate, and other esters; and furfuryl alcohol, tetrahydrofurfuryl alcohol, thiodiglycol, glycerin and the like. Examples of saccharides include maltitol, sorbitol, gluconolactone, maltose, and the like.

Adding the water-soluble organic solvent in the range of preferably 5 to 40 wt %, more preferably 10 to 30 wt %, and even more preferably 10 to 20 wt %, with respect to the total amount of the liquid composition enables the drying rate to be easily controlled.

Additionally, the liquid composition used in the invention can contain a surfactant to provide cleaning and wetting of the member surface and to assure stable dissolution of the diacetylene tetraol represented by General Formula (1).

For the surfactant, soap, N-acyl amino acid salts, polyoxyethylene or polyoxypropylene alkyl ether carboxylic acid salts, acylated peptides, alkyl sulfonates, alkyl benzene and alkyl naphthalene sulfonates, naphthalene sulfonates, sulfosuccinates, α-olefin sulfonates, N-acyl sulfonates, sulfonated oil, alkyl sulfates, alkyl ether sulfates, polyoxyethylene or polyoxypropylene alkyl allyl ether sulfates, alkyl amide sulfates, alkyl phosphates, polyoxyethylene or polyoxypropylene alkyl allyl phosphates, and the like can be used as an anionic surfactant.

Alkylamine salts, aliphatic quaternary ammonium salts, benzalkonium chloride, benzethonium chloride, pyridinium salts, imidazolium salts, and the like can be used as a cationic surfactant.

Carboxybetaines, amino carboxylic acid salts, imidazolium betaine, lecithin, alkylamine oxides, and the like can be used as an ampholytic surfactant.

Polyoxyethylene alkyl and alkyl phenyl ethers, formaldehyde-condensed polyoxyethylene alkyl allyl ethers, polyoxyethylene-polyoxypropylene block polymers, polyoxyethylene-polyoxypropylene alkyl ethers, glycerin ester polyoxyethylene ethers, sorbitan ester polyoxyethylene ethers, and sorbitol ester polyoxyethylene ethers; and as esters, polyethylene glycol fatty acid esters, glycerin esters, polyglycerin esters, sorbitan esters, propylene glycol esters, sucrose esters, fatty acid alkanol amides, polyoxyethylene fatty acid amides, polyoxyethylene alkyl amides, and fluorinated surfactants can be used as a nonionic surfactant.

When utilizing a nonionic surfactant, high-temperature drying performed while the member is immersed in the liquid composition may interfere with formation of the layer containing the diacetylene tetraol compound represented by General Formula (1). Therefore, among the above surfactants it is preferable to use an anionic surfactant, cationic surfactant or amphoteric surfactant.

A pH regulator, solubilizing aid, antioxidant, preservative, antifungal agent, rust inhibitor, and the like can be used as needed in the liquid composition of the invention.

With respect to additives, diethanolamine, triethanolamine, propanol amine, morpholine and other amines and denatured forms thereof; potassium hydroxide, sodium hydroxide, lithium hydroxide and other metal hydroxides; ammonium hydroxide, quaternary ammonium hydroxides (such as tetramethyl ammonium) and other ammonium salts; potassium carbonate, sodium carbonate, lithium carbonate, and other carbonates and phosphates; N-methyl-2-pyrrolidone, 2-pyrrolidone and other pyrrolidones; urea, thiourea, tetramethyl urea, and other ureas; allophanate, methyl allophanate and other allophanates; biuret, methyl biuret, tetramethyl biuret and other biurets; L-ascorbic acid and salts thereof; and the like can be used specifically for the pH regulator, solubilizing aid, and antioxidant.

Examples of preservatives and antifungal agents that can be used include sodium benzoate, sodium pentachlorophenol, sodium 2-pyridinethiol-1-oxide, sodium sorbate, sodium dehydroacetate, 1,2-benzisothiazolin-3-one (Proxel CRL™, Proxel BDN™, Proxel GXL™, Proxel XL-2™, and Proxel TN™ manufactured by AVECIA), and the like. These components can be used individually, or a mixture of a plurality thereof selected from within each group or among groups can be used.

### EXAMPLES

The invention is described more specifically below through examples and comparative examples, but the invention is by no means limited to the examples disclosed herein.

Preparation of liquid composition containing diacetylene tetraol compound

A liquid composition disclosed in Table 1 and Table 2 containing the diacetylene tetraol compound represented by General Formula (1) was prepared as the liquid composition. More specifically, each starting material was thoroughly mixed and dissolved in the solvent, and filtered under pressure with a membrane filter having a pore size of approximately 0.8 μm to prepare the liquid composition. The ingredients are shown in Table 1.

TABLE 1

| Material | Wt % |
|---|---|
| Diacetylene tetraol compound A | 0.05 |
| 2-ethylhexyl hexaethylene glycol | 3.00 |
| Glycerin | 10.00 |
| Triethylene glycol | 10.00 |
| Proxel XL-2 | 0.30 |
| Benzotriazole | 0.01 |
| Water | 76.64 |
| | 100.00 |

Table 2 shows the structure of the diacetylene tetraol compound used (values for R₁, R₂, k, l, m, and n in General Formula (1)). The number 3 in R₁ and R₂ of Table 2 indicates the number of carbon atoms present in the alkyl groups.

TABLE 2

| Name | R₁ &R₂ | k, l, m, n |
|---|---|---|
| Diacetylene tetraol compound A | 3 | 2 |

Base Material

To verify air bubble adhesion visually a 3 mm diameter by 15 mm long tube was formed from a cyclic olefin copolymer (hereinafter, COC), which is an optical plastic.

Ink Channels

Using a base material consisting of the above COC, ink channels were fabricated by bending the tube every 5 mm at 90° to create a U-shaped form with squared corners. Primarily, the adhesion of air bubbles often occurs at these kinds of bends.

Immersion and Drying

The COC ink channels formed in the above manner were flushed by fitting them into inkjet heads, the liquid composition containing the diacetylene tetraol compound represented by General Formula (1) of the invention was drawn into the inkjet heads, and the COC ink channels were thereby immersed therein. At this time care was taken to insure that no air bubbles adhered to the inside the COC ink channels. Thereafter, the ink channels were let stand undisturbed to dry under the conditions shown in Table 3, Table 4, and Table 5. Drying was performed by removing all the COC ink channels from the inkjet head and insuring that the circulation pathways on both ends were open.

TABLE 3

| Condition | Ex. 1 | Ex. 2 | Ex. 3 | Ex. 4 | Ex. 5 | Ex. 6 |
|---|---|---|---|---|---|---|
| No. of days | 1 | 2 | 3 | 4 | 5 | 6 |
| dried (days) | | | | | | |
| drying | Normal | Normal | Normal | Normal | Normal | Normal |
| temperature | | | | | | |
| (° C.) | | | | | | |
| Drying rate | 0 | 0 | 1 | 2 | 2 | 3 |
| (points) | | | | | | |
| Adhesion of air | 1 | 1 | 3 | 3 | 4 | 4 |
| bubbles (—) | | | | | | |

TABLE 4

| Condition | Ex. 7 | Ex. 8 | Ex. 9 | Ex. 10 | Ex. 11 | Ex. 12 |
|---|---|---|---|---|---|---|
| No. of days dried | 1 | 2 | 3 | 4 | 5 | 6 |
| (days) | | | | | | |
| Drying temperature | 40 | 40 | 40 | 40 | 40 | 40 |
| (° C.) | | | | | | |
| Drying rate (points) | 0 | 1 | 3 | 4 | 5 | 6 |
| Adhesion of air | 1 | 3 | 3 | 4 | 4 | 5 |
| bubbles (—) | | | | | | |

TABLE 5

| | Ex. | Ex. | Ex. | Ex. | Ex. | Ex. |
|---|---|---|---|---|---|---|
| Condition | 13 | 14 | 15 | 16 | 17 | 18 |
| No. of days dried | 1 | 2 | 3 | 4 | 5 | 6 |
| (days) | | | | | | |
| Drying temperature (° C.) | 60 | 60 | 60 | 60 | 60 | 60 |
| Drying rate (points) | 2 | 4 | 5 | 6 | 6 | 7 |
| Adhesion of air bubbles | 4 | 5 | 5 | 5 | 5 | 5 |
| (—) | | | | | | |

Evaluation of Air Bubble Adhesion

After letting them dry undisturbed in the above manner, the COC ink channels were again fitted into the inkjet heads, flushed with ultrapure water having a specific resistance value of 15 MΩ or more, and the quantity of air bubbles adhering to the inside of the COC ink channels was assigned a score based on the following scale: “None adhering 5>4>3>2>1 Many adhering.” A channel forming member that had not been immersed in the liquid composition containing the constituent compound of the invention was evaluated, and the number of air bubbles adhering thereto was assigned a score of 1 point. A small amount of colorant was added to the liquid composition containing the constituent compound of the invention to assure visual recognition, and the ejection status and printed matter were observed. It was found that ejection directionality problems tended to occur more frequently, and the quality of the printed matter became more uneven as the quantity of adhering air bubbles increased.

The drying rate was calculated by measuring the change in weight of the liquid composition remaining in the COC ink channels before and after letting them stand to dry. The drying rate was divided into ranks of 10 wt % each from the standpoint of test precision, and the following scores were assigned: <10%, 0 points; ≧10% but <20%, 1 point; ≧20% but <30%, 2 points; ≧30% but <40%, 3 points; ≧40% but <50%, 4 points, ≧50% but <60%, 5 points; ≧60% but <70%, 6 points, and ≧70% but <80%, 7 points.

The invention not only reduces the detrimental effects caused by adhesion of air bubbles to an ink channel forming member and enables normal ejection to be obtained, but also features a member that facilitates obtaining a head structure indispensable for improved print quality in the future, an ink channel using that member, and an inkjet head using that member.

What is claimed is:

1. An ink channel forming member, wherein a layer containing a diacetylene tetraol compound represented by General Formula 1 below is formed on the surface of a base material, and the layer inhibits adhesion of air bubbles thereto: 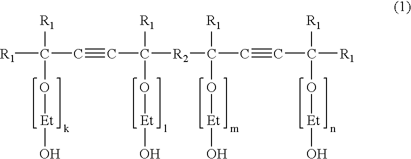
(wherein R₁ and R₂ each independently represent an alkyl group of 1 to 3 carbon atoms; —O-Et- represents an oxyethylene group; and k, l, m, and n each represent an integer from 0 to 2).

2. The ink channel forming member according to claim 1, wherein the layer is formed by immersing the base material in a liquid composition containing the diacetylene tetraol compound.

3. The ink channel forming member according to claim 2, wherein, after the immersion, 10% or more of the volume of the liquid composition adhering to the base material is dried thereon.

4. The ink channel forming member according to claim 2, wherein the immersion is performed for 3 days or more at normal temperature or above.
